(19) United States
(12) Patent Application Publication
(10) Pub. No.: US 2026/0336915 A1
(43) Pub. Date: Oct. 29, 2026

(54) REMOTE CONTROLLED MATERIAL DELIVERY SYSTEM

(71) Applicant: First Power Group, LLC, Twinsburg, OH (US)

(72) Inventors: John W. Harley, Peninsula, OH (US); Edward Nolan, Wadsworth, OH (US)

(73) Assignee: First Power Group, LLC, Twinsburg, OH (US)

(21) Appl. No.: 19/190,578

(22) Filed: Apr. 25, 2025

(51) Int. Cl. B65D 83/16; B65D 83/48; H02B 3/00

(52) U.S. Cl. CPC B65D 83/16; B65D 83/48; H02B 3/00

(57) ABSTRACT

Provided in this disclosure is a remotely controlled material delivery system with least one canister, a nozzle, a manifold, a valve mechanism, an actuator system, a flow tube, a signal receiver, a power source, and a remote controller operable to generate the signal wherein the signal is transmitted from the remote controller to the signal receiver through a transmitter circuit, wherein the receiver can activate the actuator system in response to the remotely generated signal. Wherein a servo motor is configured to rotate at least one actuator cam when the actuator system activates, and wherein the at least one actuator cam is engaged with a valve plate, and configured such that when the at least one actuator cam rotates, a valve stem will slide vertically, relative to the valve base, allowing release of a material.

### A. TECHNICAL FIELD

This invention generally relates to methods and apparatuses related to remotely applying a fluid material and more specifically to methods and apparatuses related to a powered valve apparatus and remotely controllable valve.

### B. DESCRIPTION OF RELATED ART

Electric switchgear that controls or switches electric power is typically mounted in hard to reach places, e.g. on utility poles and substations. This equipment requires periodic maintenance, in particular application of penetrating oils, cleaners, and lubricants to keep it operable. In many cases, these devices require lubrication while they are powered on, where the operating voltages can reach into the tens or hundreds of thousands of volts. Thus it can be quite hazardous in terms of electrical shock to the personnel conducting the maintenance. A current lubrication solution typically involves a hand-held aerosol spray can, or an apparatus that can hold and disperse the contents of an aerosol spray can. This has disadvantages in that the user performing the maintenance may need to get in potentially dangerous close proximity to the live circuit, and also limits the application to whatever type of lubricant is available in an aerosol can. Another known solution involves attaching an aerosol spray can to the end of an extension, such as a pole or a “hot-stick” with a string or rope running down from the can to the operator. This device requires two hands to operate, with one holding the extension and another pulling the string or rope to activate the aerosol can. This can be physically awkward for the operator. If the operator pulls too hard on the rope, it may dislodge the can, possibly causing personal injury, or an electrical fault on the electric device, and at a minimum requiring the operator to re-attach the can. Additionally, the rope does not provide as high a degree of insulation as the hot stick, so in a high voltage environment, this usage could possibly cause electric shock to the operator by providing an arc path. This method is also prone to inaccurate dispersion of the lubricant, which is undesirable.

Previous attempts to resolve these issues, in particular the device described in U.S. Pat. No. 10,746,353, have included a fluid-filled manifold and have been too cumbersome and costly to produce and use. Additionally, such previous attempts have required a manifold to contain a material such that the material remains in the manifold until dispensed. This manner of construction and operation is less sturdy than desirable, and merits improvement.

What is needed is an apparatus that provides safety for the maintenance personnel, accurate placement of the lubricant, and the flexibility of using different types of lubricants or other materials that may or may not be available in an aerosol can, which apparatus also has a more rugged design.

### II. SUMMARY

In accordance with an aspect of the present invention, a remotely controlled material delivery system including at least one canister, having a sealable port, and configured to contain a material to be dispensed. The remotely controlled material delivery system may further include a nozzle, separate from the at least one canister and having a first end and a second end, and a manifold, separate from the at least one canister and having a first attachment point and a second attachment point, to direct movement of the material from the at least one canister to the nozzle. The remotely controlled material delivery system may also include a valve mechanism, affixed to the manifold, and having a valve base, a valve stem, having a first end and a second end, a valve actuator disposed at the first end of the valve stem, and a valve plate, disposed at the second end of the valve stem. The valve base may be sealably engaged with the canister sealable port, and the valve stem may be slidably engaged with the valve base. The remotely controlled material delivery system may further include an actuator system having a servo motor and at least one actuator cam rotatably connected to the servo motor. The remotely controlled material delivery system may further include a flow tube having a first end and a second end, a signal receiver, incorporated into the manifold, for receiving a signal that causes the actuator system to activate, a power source, incorporated into the manifold, for providing electric power to energize the actuator system to activate upon receiving the signal, and a remote controller operable to generate the signal wherein the signal may be transmitted from the remote controller to the signal receiver through a transmitter circuit, wherein the receiver can activate the actuator system in response to the remotely generated signal. The servo motor may be configured to rotate the at least one actuator cam when the actuator system activates, and the at least one actuator cam may be engaged with the valve plate, and configured such that when the at least one actuator cam rotates, the valve stem will slide vertically, relative to the valve base.

In accordance with another element of the invention, the remotely controlled material delivery system may further include a mounting adapter, incorporated into the manifold, and attached to an adapter at a working end of a hot stick extension that provides access to locations out of physical reach. The remotely controlled material delivery system, wherein the at least one canister is engaged with the first attachment point of the manifold, the first end of the flow tube is engaged with the second end of the valve stem, and the first end of the nozzle is engaged with the second end of the flow tube and the manifold second attachment point. The remotely controlled material delivery system, wherein the nozzle is attached to the manifold by a “quick-connect” fitting. The remotely controlled material delivery system, wherein the valve actuator may be a substantially flat insert, the valve actuator at least partially extends from the first end of the valve stem, and the valve actuator is in contact with the sealable port of the at least one canister.

In accordance with another element of the invention, the remotely controlled material delivery system may further include, a fluid flow assembly including the nozzle, the valve mechanism, the flow tube, a check valve, and a one-way stop abutting the valve plate. The valve plate may be oil-filled bronze, and the remotely controlled material delivery system may further include a servo cover plate, which may at least partially cover the actuator system and fluid flow assembly and a printed circuit board (PCB) disposed within the manifold. The printed circuit board (PCB) may be electrically connected to the power source and the signal receiver, and the signal receiver may be an antenna.

In accordance with another element of the invention, the remotely controlled material delivery system, wherein the remote controller further includes a controller housing having an upper case and a lower case, an input mechanism, a light pipe, and a printed circuit board (PCB). The input mechanism, light pipe, and printed circuit board may be disposed within the controller housing, and the input mechanism and light pipe may extend at least partially outside the controller housing.

In accordance with another element of the invention, a remotely controlled material delivery system comprising at least one canister, having a sealable port, and configured to contain a material to be dispensed, a nozzle, separate from the at least one canister, having a first end and a second end, and a manifold, separate from the at least one canister and having a first attachment point and a second attachment point, to direct movement of the material from the at least one canister to the nozzle. The remotely controlled material delivery system may also include a valve mechanism, affixed to the manifold, and having a valve base, a valve stem, having a first end and a second end, a valve actuator disposed at the first end of the valve stem, and a valve plate, disposed at the second end of the valve stem, wherein the valve base may be sealably engaged with the canister sealable port, and wherein the valve stem may be slidably engaged with the valve base. The remotely controlled material delivery system may also include an actuator system having a servo motor, and at least one actuator cam rotatably connected to the servo motor. The remotely controlled material delivery system may also include a flow tube having a first end and a second end, a signal receiver, incorporated into the manifold, for receiving a signal that causes the actuator system to activate, a power source, incorporated into the manifold, for providing electric power to energize the actuator system to activate upon receiving the signal, and a camera that may be selectively operable to take still frame photographs and record video. The remotely controlled material delivery system may also include a remote controller operable to generate the signal wherein the signal may be transmitted from the remote controller to the signal receiver through a transmitter circuit, wherein the receiver can activate the actuator system in response to the remotely generated signal, and the signal may be transmitted through a wireless connection from the remote controller to the signal receiver. Wherein the servo motor may be configured to rotate the at least one actuator cam when the actuator system activates, and wherein the at least one actuator cam may be engaged with the valve plate, and configured such that when the at least one actuator cam rotates, the valve stem will slide vertically, relative to the valve base.

In accordance with another element of the invention, the remotely controlled material delivery system further including a mounting adapter, incorporated into the manifold, and attached to an adapter at a working end of a hot stick extension that provides access to locations out of physical reach, wherein the camera may be disposed on the hot stick extension. The remotely controlled material delivery system, wherein the at least one canister is engaged with the first attachment point of the manifold, the first end of the flow tube is engaged with the second end of the valve stem, and the first end of the nozzle is engaged with the second end of the flow tube and the manifold second attachment point. The remotely controlled material delivery system, wherein the nozzle is attached to the manifold by a “quick-connect” fitting. The remotely controlled material delivery system, wherein the valve actuator may be a substantially flat insert, the valve actuator at least partially extends from the first end of the valve stem, and the valve actuator is in contact with the sealable port of the at least one canister.

In accordance with another element of the invention, the remotely controlled material delivery system may further include, a fluid flow assembly including the nozzle, the valve mechanism, the flow tube, a check valve, and a one-way stop abutting the valve plate. The valve plate may be oil-filled bronze, and the remotely controlled material delivery system may further include a servo cover plate, which may at least partially cover the actuator system and fluid flow assembly and a printed circuit board (PCB) disposed within the manifold. The printed circuit board (PCB) may be electrically connected to the power source and the signal receiver, and the signal receiver may be an antenna.

In accordance with another element of the invention, the remotely controlled material delivery system, wherein the remote controller further includes a controller housing having an upper case and a lower case, an input mechanism, a light pipe, and a printed circuit board (PCB). The input mechanism, light pipe, and printed circuit board may be disposed within the controller housing, and the input mechanism and light pipe may extend at least partially outside the controller housing.

In accordance with another element of the invention, a remotely controlled material delivery system comprising, a material hose configured to deliver a material to be dispensed, a nozzle, separate from the at least one canister, having a first end and a second end, and a manifold, separate from the at least one canister and having a first attachment point and a second attachment point, to direct movement of the material from the material hose to the nozzle. The remotely controlled material delivery system may further include a valve mechanism, affixed to the manifold, and having, a valve base, a valve stem, having a first end and a second end, a valve actuator disposed at the first end of the valve stem, a valve plate, disposed at the second end of the valve stem, wherein the valve base may be sealably engaged with the material hose, and wherein the valve stem may be slidably engaged with the valve base. The remotely controlled material delivery system may further include an actuator system having a servo motor and at least one actuator cam rotatably connected to the servo motor, a flow tube having a first end and a second end, a signal receiver, incorporated into the manifold, for receiving a signal that causes the actuator system to activate, a power source, incorporated into the manifold, for providing electric power to energize the actuator system to activate upon receiving the signal, a remote controller operable to generate the signal wherein the signal may be transmitted from the remote controller to the signal receiver through a transmitter circuit, wherein the receiver can activate the actuator system in response to the remotely generated signal, wherein the servo motor may be configured to rotate the at least one actuator cam when the actuator system activates, and wherein the at least one actuator cam may be engaged with the valve plate, and configured such that when the at least one actuator cam rotates, the valve stem will slide vertically, relative to the valve base.

In accordance with another element of the invention, the remotely controlled material delivery system further including a mounting adapter, incorporated into the manifold, and attached to an adapter at a working end of a hot stick extension that provides access to locations out of physical reach. The remotely controlled material delivery system, wherein the material hose may be engaged with the first attachment point of the manifold, the first end of the flow tube is engaged with the second end of the valve stem, and the first end of the nozzle is engaged with the second end of the flow tube and the manifold second attachment point. The remotely controlled material delivery system, wherein the valve actuator may be a substantially flat insert, the valve actuator at least partially extends from the first end of the valve stem, and the valve actuator is in contact with the sealable port of the at least one canister.

In accordance with another element of the invention, the remotely controlled material delivery system may further include, a fluid flow assembly including the nozzle, the valve mechanism, the flow tube, a check valve, and a one-way stop abutting the valve plate. The valve plate may be oil-filled bronze, and the remotely controlled material delivery system may further include a servo cover plate, which may at least partially cover the actuator system and fluid flow assembly, and a printed circuit board (PCB) disposed within the manifold. The printed circuit board (PCB) may be electrically connected to the power source and the signal receiver, and the signal receiver may be an antenna.

In accordance with another element of the invention, the remotely controlled material delivery system, wherein the remote controller further includes a controller housing having an upper case and a lower case, an input mechanism, a light pipe, and a printed circuit board (PCB). The input mechanism, light pipe, and printed circuit board may be disposed within the controller housing, and the input mechanism and light pipe may extend at least partially outside the controller housing.

Other benefits and advantages of this invention will become apparent to those skilled in the art to which it pertains upon reading and understanding of the following detailed specification.

### III. BRIEF DESCRIPTION OF THE DRAWINGS

The disclosed remotely controlled material delivery system may take physical form in certain parts and arrangement of parts, embodiments of which will be described in detail in this specification and illustrated in the accompanying drawings which form a part hereof and wherein:

FIG. 1 is a side view of a remotely controlled material delivery system according to some embodiments of this subject matter;

FIG. 2 is an opposite side view of the remotely controlled material delivery system of FIG. 1, showing a power source according to some embodiments of this subject matter;

FIG. 3 is rear view of the remotely controlled material delivery system of FIG. 1, according to some embodiments of this subject matter;

FIG. 4 is a top view of the remotely controlled material delivery system of FIG. 1, according to some embodiments of this subject matter;

FIG. 5 is a side section view of the of the remotely controlled material delivery system of FIG. 1, according to some embodiments of this subject matter;

FIG. 6 is a detail section view of the remotely controlled material delivery system of FIG. 1, showing a valve mechanism according to some embodiments of this subject matter;

FIG. 7 is a side view of a remotely controlled material delivery system according to some embodiments of this subject matter;

FIG. 8 is a top view of the remotely controlled material delivery system of FIG. 7, according to some embodiments of this subject matter;

FIG. 9 is a perspective view of the remotely controlled material delivery system of FIG. 7, according to some embodiments of this subject matter;

FIG. 10 is an exploded perspective view of the remotely controlled material delivery system of FIG. 7, showing the canister, according to some embodiments of this subject matter;

FIG. 11 is an exploded perspective view of the power source of the remotely controlled material delivery system of FIG. 7, according to some embodiments of this subject matter;

FIGS. 12-14 are respective internal views of the manifold of the remotely controlled material delivery system of FIG. 7, according to some embodiments of this subject matter;

FIG. 15 is an exploded view of internal components of the manifold of the remotely controlled material delivery system of FIG. 7, according to some embodiments of this subject matter;

FIG. 16A is a front view of certain components of the valve mechanism, according to some embodiments of this subject matter;

FIG. 16B is a section view of the valve mechanism of FIG. 16A, according to some embodiments of this subject matter;

FIG. 16C is a detail view of the valve mechanism of FIG. 16A, showing the valve actuator, according to some embodiments of this subject matter;

FIG. 17 is an exploded view of the valve mechanism of FIG. 16A, according to some embodiments of this subject matter;

FIG. 18 is a perspective view of a remote controller, according to some embodiments of this subject matter; and

FIG. 19 is an exploded view of the remote controller of FIG. 18, according to some embodiments of this subject matter.

### IV. DETAILED DESCRIPTION

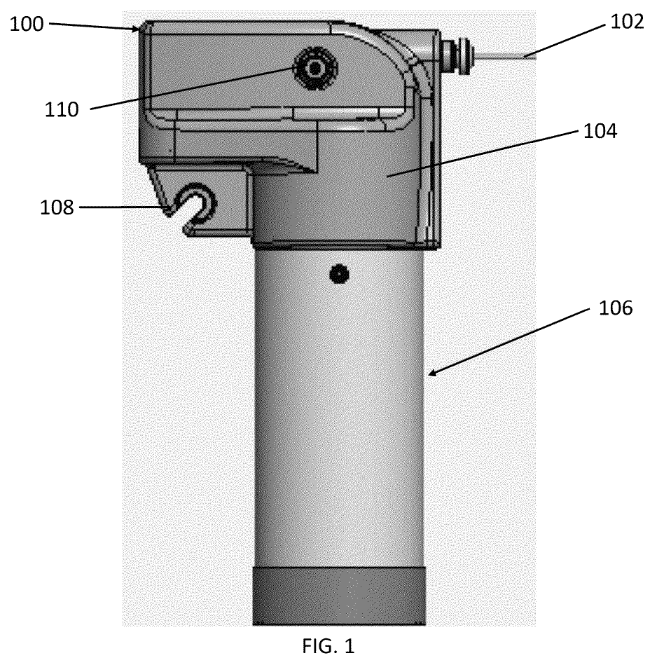

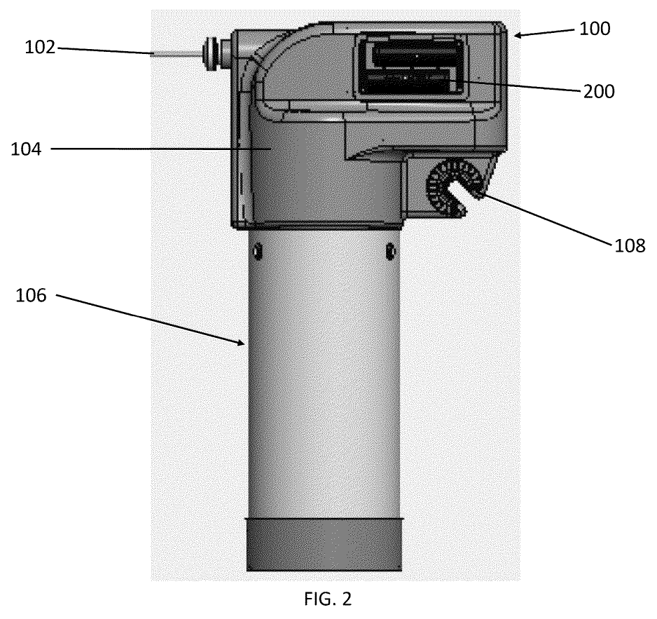

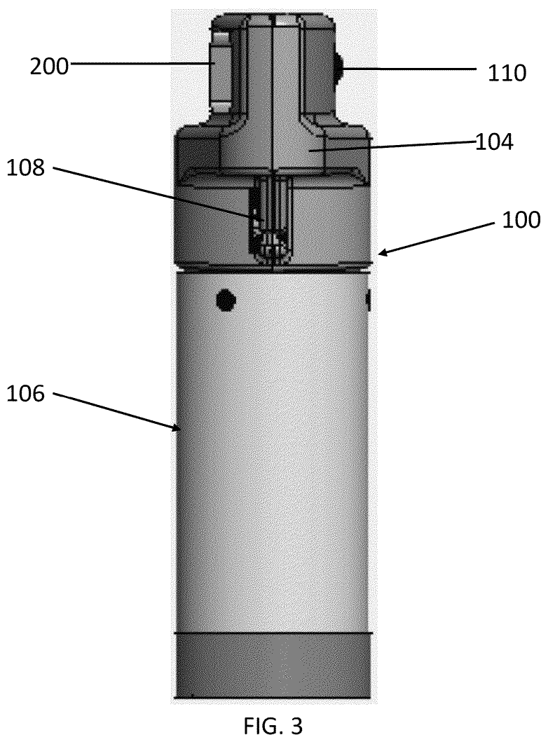

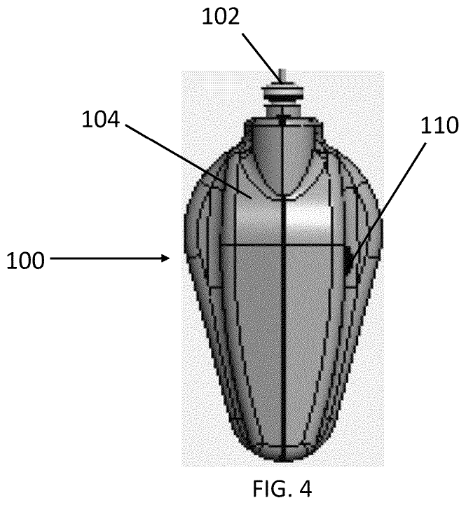

Referring now to the drawings, wherein the showings are for purposes of illustrating embodiments of the invention only and not for purposes of limiting the same, and wherein like reference numerals are understood to refer to like components, FIGS. 1, 2, 3, and 4 show a remotely controlled material delivery system 100 according to some embodiments of the present subject matter. The remotely controlled material delivery system may include a nozzle 102, which may be separate from the at least one canister and have a first end and a second end, a manifold 104, a canister assembly 106, a power source 200 incorporated into the manifold 104, and a power switch 110 incorporated into the manifold 104. The power switch 110 may be lighted or otherwise include an “on/off” light, “power” light, or any other indicator chosen according to sound engineering judgment. The manifold 104 may be separate from the canister assembly 106, have a first attachment point and a second attachment point, and be configured to direct movement of material from at least one canister, or at least one material hose, in the canister assembly 106 to the nozzle 102, as described further below. The power source 200 can be a standard or rechargeable battery, or solar panel, or other type of power source, and can be connected mechanically to the system via a bracket to one of the other components, or it can be located in a housing or enclosure. The power source 200 can be connected electrically to the system via a standard electrical battery terminal, or by soldering, or the like. The remotely controlled material delivery system may also include a printed circuit board housing 520.

In a particular embodiment, the remotely controlled material delivery system 100 may also include a mounting adapter 108, incorporated into the manifold 104, and attached to an adapter at a working end of a hot stick extension, or other extension device chosen according to sound engineering judgment, that provides access to locations out of physical reach. In yet another embodiment, the remotely controlled material delivery system 100 may also include a camera, which may be disposed on the manifold or mounted to the hot stick extension. The remotely controlled material delivery system 100 may also include a remote controller operable to generate and transmit a signal to the signal receiver through a transmitter circuit, which may cause the receiver to activate the actuator system in response to the remotely generated signal and engage the remotely controlled material delivery system 100 to dispense material, as discussed further below. In a particular embodiment, the signal may be transmitted through a wireless connection or through an optical connection from the remote controller to the signal receiver.

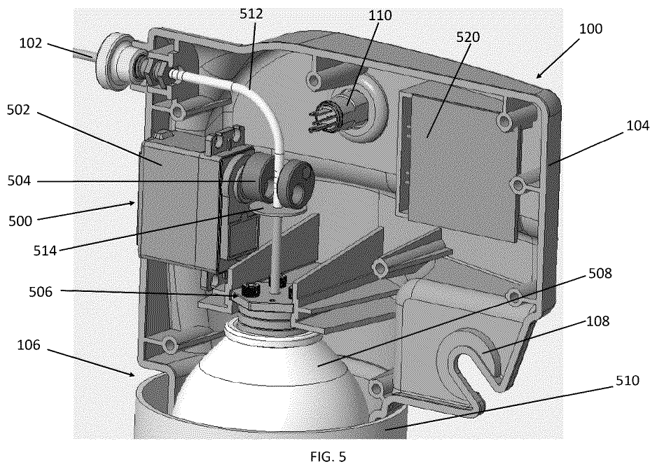

With reference to FIG. 5, the remotely controlled material delivery system 100 may include an actuator system 500, a valve mechanism 506 affixed to the manifold 104, and a flow tube 512, which may have a first end and a second end. The canister assembly 106 may further include at least one canister 508, configured to contain a material to be dispensed, and a canister sheath 510, which may enclose the at least one canister 508. The actuator system 500 may further include a servo motor 502 and at least one actuator cam 504 rotatably connected to the servo motor 502. In a particular embodiment, the remotely controlled material delivery system 100 may alternatively include a material hose configured to deliver a material to be dispensed. The material hose, which may also include a plurality of material hoses, may extend from at least one canister, a plurality of canisters, a material reservoir, or any other container, chosen according to sound engineering judgment, configured to hold the material to be dispensed.

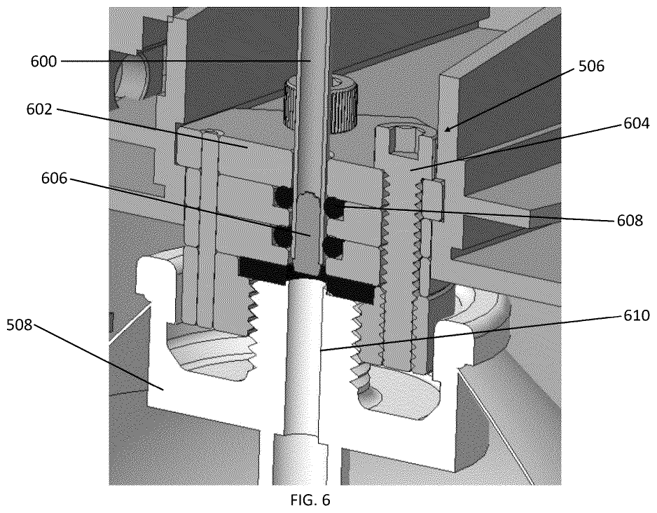

With reference to FIGS. 5 and 6, the valve mechanism 506 of the remotely controlled material delivery system 100 may include a valve base 602, a hollow valve stem 600 having a first end and a second end, a valve actuator 606 disposed at the first end of the valve stem 600, and a valve plate 514 disposed along the length of the valve stem 600—and in a particular embodiment, at the second end of the valve stem 600. The valve base 602 may be constructed and held together via at least one fastener 604, which may be screws, rivets, bolts, or any other securement mechanism chosen according to sound engineering judgment. In a particular embodiment, the valve base 602 may include internal threading, such that it may facilitate a threaded connection between the valve base 602 and the at least one canister 508. The at least one canister 508 may have a sealable port 610. The valve base 602 may be sealably engaged with the canister sealable port 610, and the valve stem 600 may be slidably engaged with the valve base 602. In the case of an embodiment featuring a material hose, the valve base 602 may be sealably engaged with the material hose, which sealable engagement may be accomplished via a threaded connection. The valve mechanism may further include seals 608 engaged with both the valve base 602 and valve stem 600 to facilitate a sealed connection while maintaining slidable engagement between the valve base 602 and valve stem 600, as described further below.

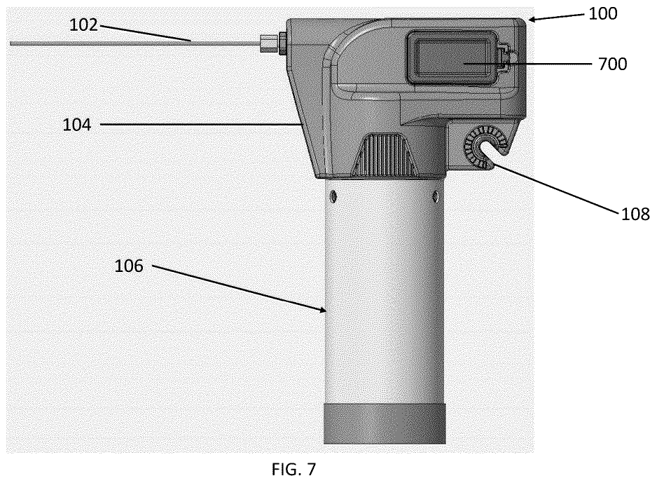

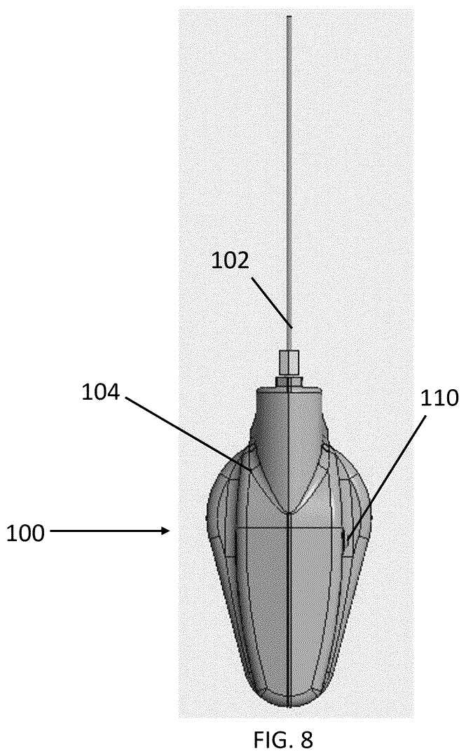

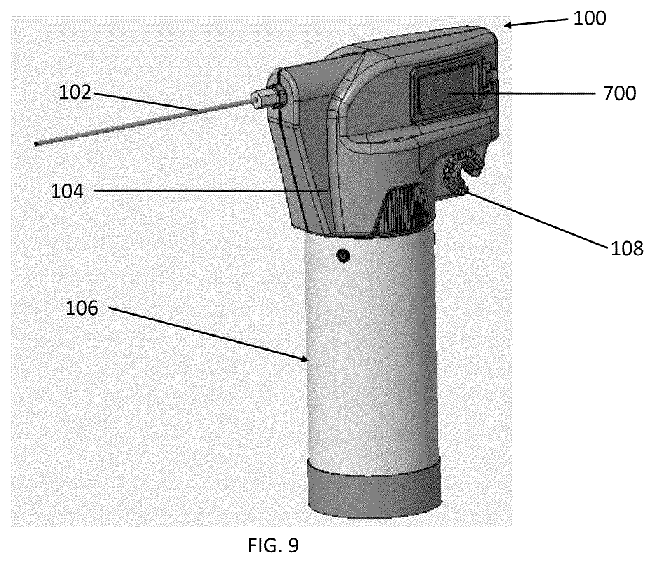

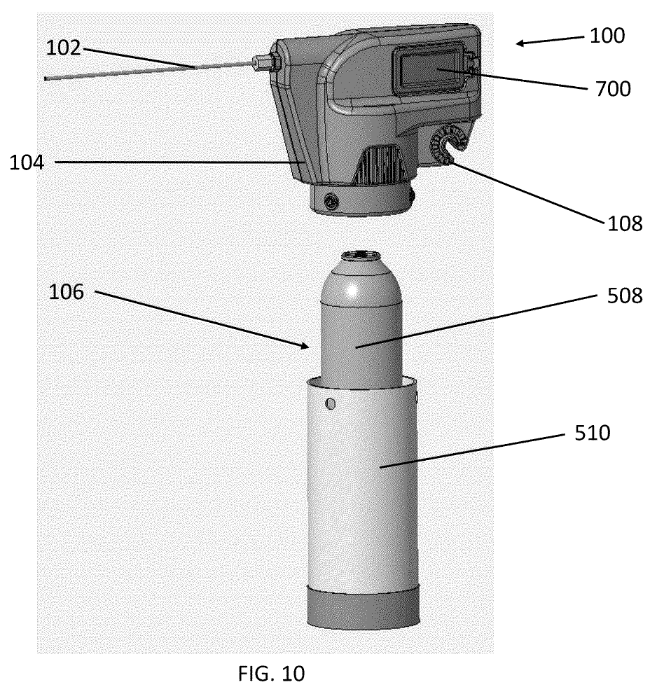

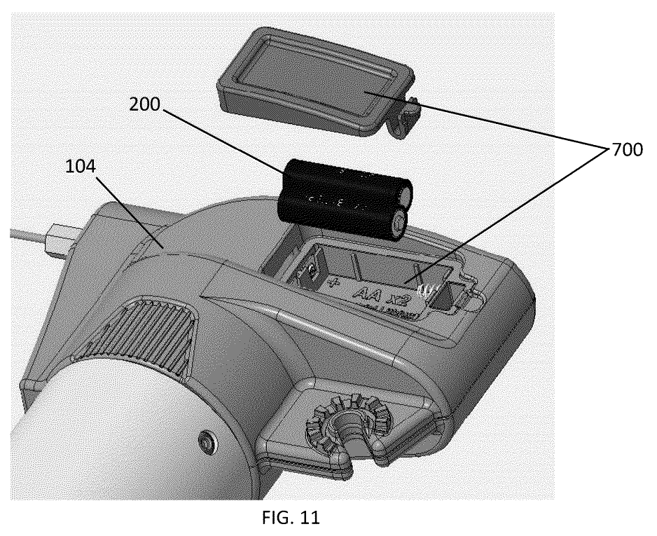

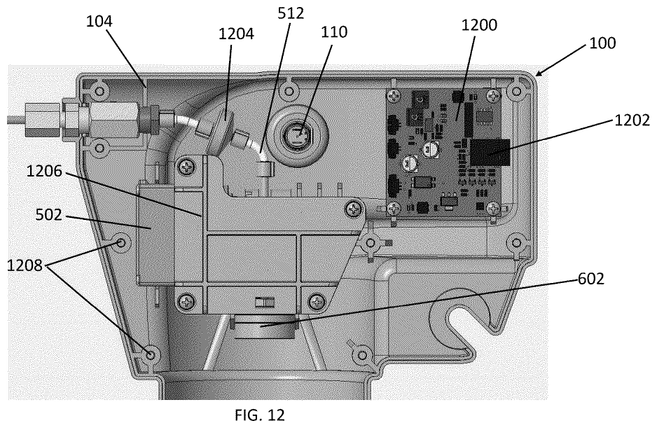

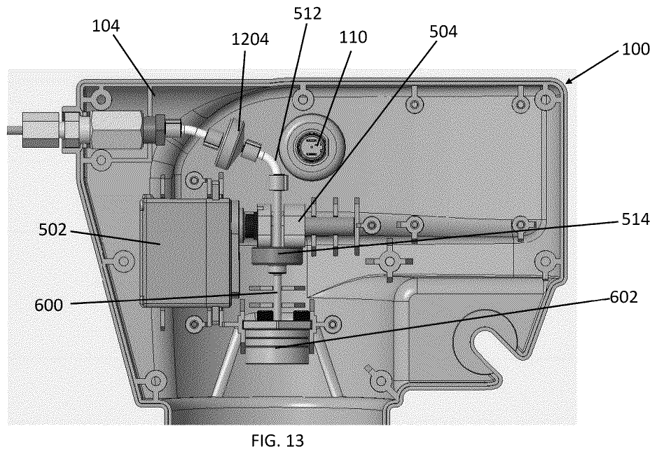

With reference to FIGS. 7, 8, 9, 10, 11, 12, 13, 14, and 15, and in accordance with a particular embodiment, the remotely controlled material delivery system 100 may include a power source compartment 700 disposed within an outside section of the manifold, a printed circuit board (PCB) 1200 disposed within the manifold 104, a signal receiver 1202 disposed on the PCB 1200, and a servo cover plate 1206 configured to abut and at least partially cover the actuator system 500. The PCB 1200 may be electrically connected to the power source 200, via wires, or any other power transmission mechanism chosen according to sound engineering judgment. In a particular embodiment, the PCB 1200 may be attached to the manifold 104 via a circuit board mount. The signal receiver 1202 may be an antenna, or any wireless signal receiver chosen according to sound engineering judgment. In a particular embodiment, the manifold 104 may be a two-piece assembly, which does not use metal fasteners, and may include non-metal fittings 1208, which may be press-fittings, plastic screws, or any other non-metal fasteners chosen according to sound engineering judgment. In a particular embodiment, the canister sheath 510 may be a dielectric material, configured to protect the can from sparks and electrical interference. The remotely controlled material delivery system 100 may also include a fluid flow assembly 1500. The power source compartment 700 may be configured to contain the power source 200.

The fluid flow assembly 1500 may include the valve mechanism 506, the nozzle 102, the flow tube 512, and a check valve 1204. The check valve 1204 may be disposed along the length of the flow tube 512. In a particular embodiment, the valve plate 514 may be oil-filled bronze. The oil-filled bronze valve plate material may function to reduce “galling” abrasive phenomenon at the point of contact between the actuator cam(s) 504 and the valve plate 514.

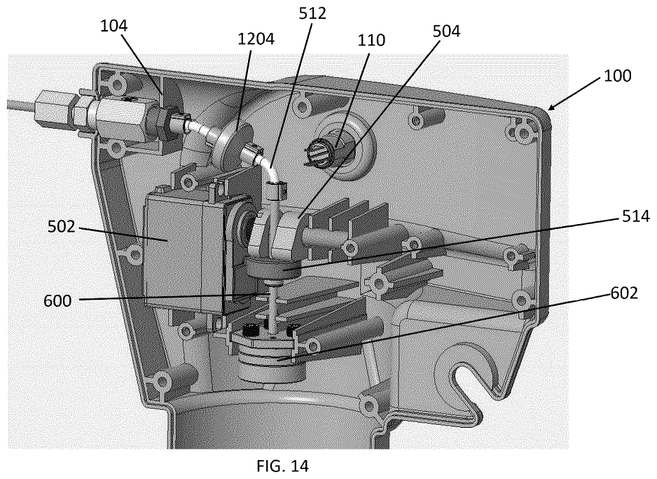

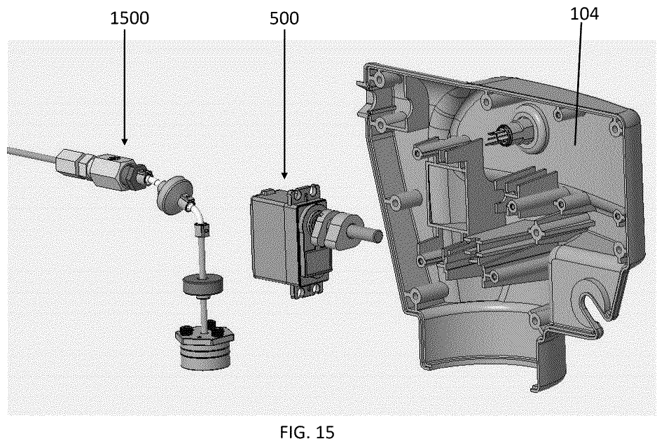

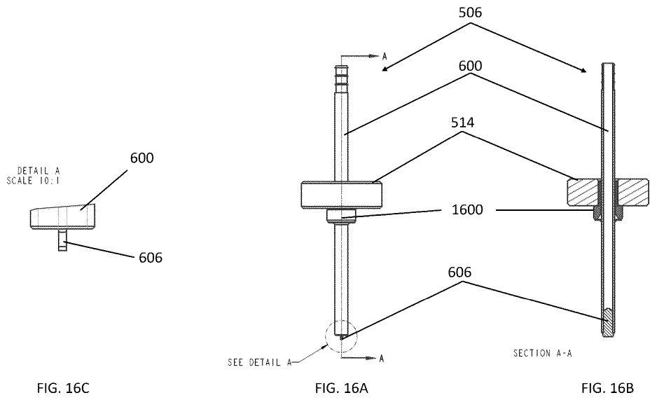

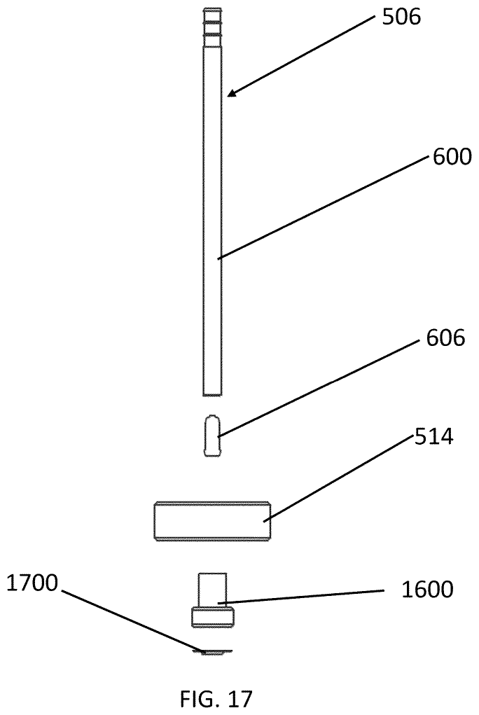

With reference to FIGS. 16A, 16B, 16C, and 17, and in accordance with a particular embodiment, the remotely controlled material delivery system 100 may include a one-way stop 1600 abutting the valve plate 514, which one-way stop may be a push-nut, a one-way bearing, or any other unidirectional mechanical stop chosen according to sound engineering judgment. In a particular embodiment, the valve actuator 606 may be a flat insert that extends at least partially from the end of the valve stem 600. A retaining mechanism 1700, which may be a washer, nut, or other mechanical stop chosen according to sound engineering judgment, may be disposed along the length of the valve stem—and in some embodiments, may be disposed abutting the one-way stop 1600.

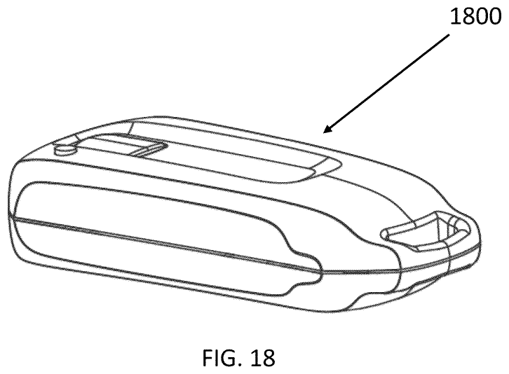

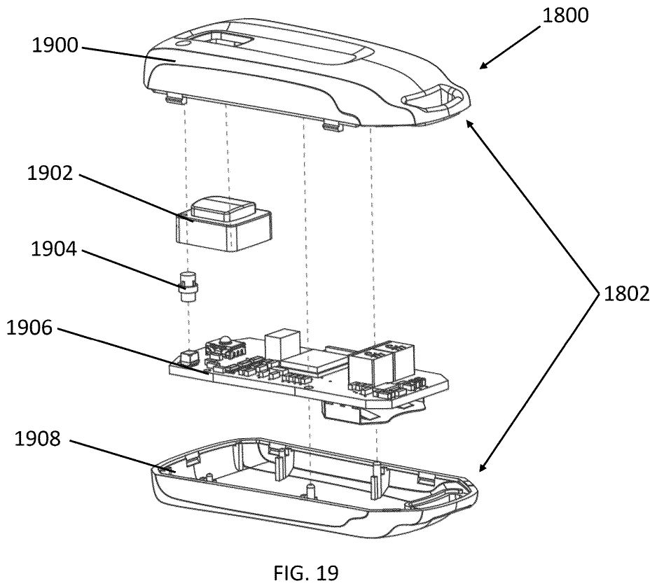

With reference to FIGS. 18 and 19, the remotely controlled material delivery system 100 remote controller 1800 may include a controller housing 1802 having an upper case 1900 and a lower case 1908, an input mechanism 1902, a light pipe 1904, and a printed circuit board (PCB) 1906. The input mechanism 1902, light pipe 1904, and printed circuit board 1906 may be disposed within the controller housing 1802, and the input mechanism 1902 and light pipe 1904 may extend at least partially outside the controller housing 1802. In some embodiments, the remote controller 1800 may take the form of a key fob.

The above-referenced features may function together to remotely dispense, or otherwise deliver a material, which in certain embodiments may be a fluid, whether pressurized or not, from a container to a workspace, surface, or product. The connection between features may be embodied in that the at least one canister 508 may be engaged with the first attachment point of the manifold 104, the first end of the flow tube 512 may be engaged with the second end of the valve stem 600, and the first end of the nozzle 102 may be engaged with the second end of the flow tube 512 and the manifold 104 second attachment point. In a particular embodiment, the nozzle 102 may be attached to the manifold 104 via a “quick-connect” fitting. In the case of an embodiment featuring a material hose, the connection between features may be such that the material hose is engaged with the first attachment point of the manifold 104, the first end of the flow tube 512 is engaged with the second end of the valve stem 600, and the first end of the nozzle 102 is engaged with the second end of the flow tube 512 and the manifold 104 second attachment point.

The remote dispensation may occur in the manner described in the following nonlimiting embodiment. The signal receiver 1202 receives a signal to cause the actuator system 500 to activate. The signal may take the form of any type or format of electromagnetic radiation (e.g. audio, supersonic, ultrasonic, infrared, RF, Wi-Fi, Zigbee, Blue-Tooth, etc.). Alternatively, the signal can be any type of acoustic or ultrasonic signal. The actuator system 500, energized with electrical power from the power source 200, engages the servo motor 502 to rotate the at least one actuator cam 504, when the actuator system 500 is activated. The at least one actuator cam 504, itself, may be engaged with the valve plate 514. The valve plate 514 may be fixedly connected to the valve stem 600, with the two features configured to move in tandem. Such that, when the at least one actuator cam 504 rotates, it will push down on the valve plate 514, causing the valve stem 600 to slide vertically, relative to the valve base 602, which valve base 602 may itself be fixed to the canister sealable port 610 via a threaded connection. Vertical translation of the valve stem 600 allows the valve stem 600 to slide through the valve base 602 with minimal interference, while seals 608—which can be rubber o-rings, foam seals, or any other sealant chosen according to sound engineering judgment—assist in maintaining a sealed system. The seal between the valve mechanism 506 and the canister sealable port 610 may be selectively disengaged by the valve actuator 606, which may be disposed at the first end of the valve stem 600 such that it may contact the canister sealable port 610. When the actuator system 500 activates, causing the at least one actuator cam 504 to move the valve stem 600, the valve actuator 606 is displaced, displacing the canister sealable port 610 similarly, selectively opening the canister sealable port 610, thus disengaging the at least one canister's seal, and allowing material to flow out of the at least one canister 508, through the canister sealable port 610, through the valve stem 600, and into flow tube 512 engaged with the second end of the valve stem 600. The material may then flow through the flow tube 512, into and through the nozzle attached at the second end of the flow tube 512, and out of the remotely controlled material delivery system 100 to the workspace, surface, or product. The at least one actuator cam 504 then completes its full rotation, ceasing to push down on the valve plate 514, and allowing the valve stem 600 to slide back to its original position relative to the valve base 602. The valve actuator 606, also restored to its original position, allows the seal between the valve mechanism 506 and the canister sealable port 610 to be reestablished. In this manner, the activation, engagement, and rotation of the at least one actuator cam 504, facilitated by the servo motor 502, and initiated by the signal received by the signal receiver 1202, may create a periodic cycling of the valve mechanism 506 between a sealed state, wherein material is prevented from flowing through the system, and an unsealed state, wherein the material is allowed to flow through the system. Such periodic cycling may facilitate dispensation of a specific quantity of material by altering the cam's 504 rotation speed, and/or the frequency of activation signals given to the signal receiver 1202.

In a particular embodiment, the at least one canister 508 can be of a refillable type, or of a single-use type such as a spray aerosol can. The material can either be under pressure, e.g. as in an aerosol can, or the at least one canister 508 can act as a reservoir that is not under pressure. The attachment of the at least one canister 508 can be configured to accommodate a standard aerosol can, which can be clamped on or otherwise attached so that the spray nozzle can be depressed. In a particular embodiment, the canister may include a threaded sealable port 610, which may threadedly connect to the valve base 602. The attachment of the at least one canister 508 can also accommodate other types of pressurized cans which require the top to be pierced with a hollow needle. The attachment of the at least one canister 508 can also accommodate a configuration wherein a standard aerosol can has the spray nozzle removed, and a tube is inserted into the top of the aerosol can as it is clamped on or otherwise attached. In some cases, the material can move from the at least one canister 508 to the manifold 104 through the valve mechanism 506 via gravity. In some cases, the material can be propelled by pressure via other means, such as compressed air.

The material to be dispensed can be of a variety of types that are used in the field of lubrication of electrical switchgear or any other material suitable for specific applications. Typical lubrication compounds that are used can include mineral oils, solvents, and synthetic lubricants that can include silicon based fluids, polyalphaolefins (PAO), ester oils, and fluorosilicone. In addition to these materials, a specially-formulated di-ester oil lubricant can be used. The material can further generally consist of any type of fluidic material including paint, solvents, penetrating oils, insecticide, cleaning solutions, water, and the like. It can also include gases such as CO2, Nitrogen, or even flammable gases such as propane or methane. In a particular embodiment, the material is preferably nonflammable, inert gases. Additionally, the nozzle 102 can provide a spray pattern, or a direct stream, or possibly a drip of material. The nozzle 102 can be constructed of either metal, plastic, or the like, as appropriate for the material to be dispersed. The nozzle 102 can also be configured to have a “quick-connect” type of fitting, as typically found on pressure washers, so that different nozzles can easily and quickly be attached to the manifold 104.

The signal receiver 1202 can typically be a printed circuit board with one or more integrated circuits, and also some passive components such as resistors, capacitors, inductors, diodes, etc. This signal receiver 1202 can also comprise a device configured to receive the electromagnetic radiation, acoustic, optical, or ultrasonic signal, such as an antenna, or microphone, or other type of transducer that can receive a signal. In a particular embodiment, the preferred signal received by the signal receiver 1202 may be a Bluetooth signal, but any wireless signal transmission method, as well as any wired signal transmission method, chosen according to sound engineering judgment, may be used to transmit a signal to the signal receiver 1202. The electrical interconnection between the signal receiver 1202, the actuator system 500, and the power source 200 can be wires. These wires can be of the stranded or solid type.

The remote controller 1800 for controlling the remotely controlled material delivery system 100 can have an input mechanism which can be connected to the power source 200 and transmitter circuit. A user can activate the input mechanism, thereby connecting the power source 200 to the transmitter circuit, which can now be energized and can transmit a signal. This signal can be received by the signal receiver 1202. When the user stops activation (e.g. stops pushing the button) of the input mechanism, the power source 200 can be disconnected from transmitter circuit, which can then stop transmitting a signal to receiver. While the signal receiver 1202 detects the presence of the signal, the actuator system 500 may continue to engage, rotating the at least one actuator cam 504, and dispensing material in the manner described above. When the receiver detects an absence of the appropriate signal, it can halt operation of the actuator system 500, which will stop rotation of the at least one actuator cam 504 and stop the flow of material through the system. The input mechanism can be a button, toggle switch, foot switch, voice activated switch, variable switch or other activation/deactivation input chosen according to sound engineering judgment. The input mechanism can also be configured to engage the actuator system 500 at intermediate levels to get the desired amount of flow of material from the nozzle 102. For example, if an operator “clicks” the input mechanism twice in quick succession, it can correlate to a particular actuator cam 504 rotation speed, and/or a particular frequency or number of activation signals given to the signal receiver 1202, etc. Additionally, the input mechanism can consist of a set of buttons, or a dial, or sliding switch, or the like, such that the flow can be controlled to the desired amount.

According to one particular embodiment, the signal receiver 1202 and remote controller 1800 can further comprise a two-way communication system wherein both the signal receiver 1202 and remote controller 1800 can be configured to both send and receive signals. The signal receiver 1202 can be a transceiver that can be in serial connection with sensors to measure data and performance. For example, the remotely controlled material delivery system 100 can include a low battery sensor and indicator, a material level sensor and indicator, a material pressure sensor and indicator, a flow meter, or a combination of any or all of these. The manifold 104 can have a display that can indicate the status of the battery, fluid levels, flow rate, and/or pressure in the canister. Additionally, or in the alternative, the receiver can transmit to the remote controller 1800 the status of the battery, fluid levels, flow rate, and/or pressure in the at least one canister 508. In turn, the remote controller 1800 can notify the operator of these statuses via visual signal, audible signal, vibration, or any other type of notification or a combination of any or all of these. According to one embodiment, the notification can be in the form of a single or multiple LED signals on the remote controller 1800 that can be illuminated to display one or more of these status to the operator.

According to a particular embodiment, a user of the system can hold the hot stick or other extension device with two hands and can hold the remote controller 1800 in one of his/her hands simultaneously. This can enable a person to move the system into the proper location with the extension, press the input mechanism, and apply the material. The remote controller 1800 can also be attached to the extension or hot stick for more convenient operation. The user can be electrically isolated from electrical equipment both by the insulating nature of the hot stick, as well as the system being wireless and not providing a path for the voltage to arc to the user. Additionally, the input mechanism for the remote controller 1800 can be a foot switch, enabling the operator to use two hands, or it can be voice activated, or it can be a toggle switch. In the case where the remotely controlled material delivery system 100 is used in conjunction with a flying or ground-based remote-controlled drone, the controller can functionally be incorporated into a remote controller 1800 for the drone, such that a user can operate the remotely controlled material delivery system 100 via using only the drone controller.

Another embodiment of the remotely controlled material delivery system 100 can include a tube or hose in place of the canister 508, which can provide a material to the valve mechanism 506 in a like fashion as the canister 508 and can allow a prolonged operation of the remotely controlled material delivery system 100 without having to replace the canister 508. This can be useful in applications that are not related to high voltage electrical switching equipment such as painting, cleaning, firefighting and the like.

According to one embodiment, the remotely controlled material delivery system 100 can include a camera mounted on the manifold 104. According to this embodiment, the receiver and remote controller 1800 can be in two-way communication such that an audio visual signal can be transmitted from the camera via the receiver to the remote controller 1800. According to this embodiment, the remote controller 1800 can include a display screen such as an LCD, LED, AMOLED, or any other suitable display screen chosen according to sound engineering judgment. Alternatively, the remote controller 1800 can include a port, such as USB, HDMI, DVI, VGA, Composite, Component, or another suitable port for connecting the remote controller 1800 to a display screen. According to another embodiment, the remote controller 1800 can communicate with a display screen wirelessly. The camera may include a wired or wireless transmitter that can communicate directly with a display screen, which can be separate or integrated into the remote controller 1800.

According to one embodiment, the camera mounted on the manifold 104 of the remotely controlled material delivery system 100 may be controlled separate from the remote controller 1800. In a particular, nonlimiting example, the camera can be in two-way communication with a separate controller such that an audio visual signal can be transmitted from the camera to the separate controller via a wired or a wireless connection. According to one embodiment, the separate controller can be a smart phone, a tablet, a smart watch, or a similar device that includes a display screen to allow a user to control the camera and remotely view what the camera is recording. According to this embodiment, the hot stick, other extension device, or drone controller can include a holder or mounting bracket configured to hold the separate controller. One nonlimiting example could be a smart phone holder disposed on the end of the hot stick near the user's hand, which would allow the user to view and control the camera separate from the remotely controlled material delivery system 100 while maintaining control over the hot stick and/or the remotely controlled material delivery system 100.

Another embodiment of the remotely controlled material delivery system 100 can include more than one canister 508 to be attached to the manifold 104, along with more than one valve mechanism 506, corresponding to the number of canisters, wherein each canister 508 can contain a specific material, such as separate colors of paint or cleaning solutions, which can subsequently be combined in the flow tube 512, and passed through the manifold 104, and out through the nozzle 102. Additionally, one canister 508 may contain a material and other canister(s) 508 may contain a pressurized gas such as CO2, which can be used as a propellant, or other gases that can react in a particular intended way with the material.

Another embodiment of the remotely controlled material delivery system 100 can include the tube or hose in place of the canister 508 or in combination with at least one additional canister 508 so that the material provided by the hose or tube can be combined with the material in the attached canister 508 in the flow tube 512. The material provided by the hose or tube could also act as a propellant, such as compressed air or water under pressure. This could be useful, for example, in the application of water based paints, insecticides, cleaning solutions, etc. that require a mixture of a concentrated material with water. This and other embodiments of the remotely controlled material delivery system 100 can have an environmental enclosure to protect it from the spray of material, water, or from rain or other potential environmental contaminants. The remotely controlled material delivery system 100 can be used on electrical distribution equipment such as switchgear, transformers, capacitors, or the like.

Numerous aspects have been described, hereinabove. While the remotely controlled material delivery system 100 provided herein has been described in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined to provide the desired characteristics. It will be apparent to those skilled in the art that the above methods and apparatuses may incorporate changes and modifications without departing from the spirit and scope of the present disclosure. It is intended to include all such modifications and alterations in so far as they come within the scope of the appended claims or the equivalents thereof. Therefore, the holder apparatus should not be limited to any single embodiment, but rather construed in breadth and scope in accordance with the recitations of the appended claims.

Having thus described the invention, it is now claimed:

What is claimed:

1. A remotely controlled material delivery system comprising:
at least one canister, having a sealable port, and configured to contain a material to be dispensed;
a nozzle, separate from the at least one canister, having a first end and a second end;
a manifold, separate from the at least one canister and having a first attachment point and a second attachment point, to direct movement of the material from the at least one canister to the nozzle;
a valve mechanism, affixed to the manifold, and having:
a valve base;
a valve stem, having a first end and a second end;
a valve actuator disposed at the first end of the valve stem;
a valve plate, disposed at the second end of the valve stem;
wherein the valve base is sealably engaged with the canister sealable port;
wherein the valve stem is slidably engaged with the valve base;
an actuator system having:
a servo motor;
at least one actuator cam rotatably connected to the servo motor;
a flow tube having a first end and a second end;
a signal receiver, incorporated into the manifold, for receiving a signal that causes the actuator system to activate;
a power source, incorporated into the manifold, for providing electric power to energize the actuator system to activate upon receiving the signal;
a remote controller operable to generate the signal wherein the signal is transmitted from the remote controller to the signal receiver through a transmitter circuit, wherein the receiver can activate the actuator system in response to the remotely generated signal;
wherein the servo motor is configured to rotate the at least one actuator cam when the actuator system activates; and
wherein the at least one actuator cam is engaged with the valve plate, and configured such that when the at least one actuator cam rotates, the valve stem will slide vertically, relative to the valve base.

2. The remotely controlled material delivery system of claim 1, further comprising a mounting adapter, incorporated into the manifold, and attached to an adapter at a working end of a hot stick extension that provides access to locations out of physical reach.

3. The remotely controlled material delivery system of claim 1, wherein the at least one canister is engaged with the first attachment point of the manifold, the first end of the flow tube is engaged with the second end of the valve stem, and the first end of the nozzle is engaged with the second end of the flow tube and the manifold second attachment point.

4. The remotely controlled material delivery system of claim 1, wherein the nozzle is attached to the manifold by a “quick-connect” fitting.

5. The remotely controlled material delivery system of claim 1, wherein:
the valve actuator is a substantially flat insert;
the valve actuator at least partially extends from the first end of the valve stem; and
the valve actuator is in contact with the sealable port of the at least one canister.

6. The remotely controlled material delivery system of claim 1, further comprising:
a fluid flow assembly including:
the nozzle;
the valve mechanism;
the flow tube;
a check valve;
a one-way stop abutting the valve plate;
wherein the valve plate is oil-filled bronze;
a servo cover plate, which at least partially covers the actuator system and fluid flow assembly;
a printed circuit board (PCB) disposed within the manifold;
wherein the printed circuit board (PCB) is electrically connected to the power source and the signal receiver; and
wherein the signal receiver is an antenna.

7. The remotely controlled material delivery system of claim 1, wherein the remote controller further comprises:
a controller housing having an upper case and a lower case;
an input mechanism;
a light pipe;
a printed circuit board (PCB);
wherein the input mechanism, light pipe, and printed circuit board are disposed within the controller housing; and
wherein the input mechanism and light pipe extend at least partially outside the controller housing.

8. A remotely controlled material delivery system comprising:
at least one canister, having a sealable port, and configured to contain a material to be dispensed;
a nozzle, separate from the at least one canister, having a first end and a second end;
a manifold, separate from the at least one canister and having a first attachment point and a second attachment point, to direct movement of the material from the at least one canister to the nozzle;
a valve mechanism, affixed to the manifold, and having:
a valve base;
a valve stem, having a first end and a second end;
a valve actuator disposed at the first end of the valve stem;
a valve plate, disposed at the second end of the valve stem;
wherein the valve base is sealably engaged with the canister sealable port;
wherein the valve stem is slidably engaged with the valve base;
an actuator system having:
a servo motor;
at least one actuator cam rotatably connected to the servo motor;
a flow tube having a first end and a second end;
a signal receiver, incorporated into the manifold, for receiving a signal that causes the actuator system to activate;
a power source, incorporated into the manifold, for providing electric power to energize the actuator system to activate upon receiving the signal;
a camera wherein the camera is selectively operable to take still frame photographs and record video;
a remote controller operable to generate the signal wherein the signal is transmitted from the remote controller to the signal receiver through a transmitter circuit, wherein the receiver can activate the actuator system in response to the remotely generated signal, and wherein the signal is transmitted through a wireless connection from the remote controller to the signal receiver;
wherein the servo motor is configured to rotate the at least one actuator cam when the actuator system activates; and
wherein the at least one actuator cam is engaged with the valve plate, and configured such that when the at least one actuator cam rotates, the valve stem will slide vertically, relative to the valve base.

9. The remotely controlled material delivery system of claim 8, further comprising:
a mounting adapter, incorporated into the manifold, and attached to an adapter at a working end of a hot stick extension that provides access to locations out of physical reach; and
wherein the camera is disposed on the hot stick extension.

10. The remotely controlled material delivery system of claim 8, wherein the at least one canister is engaged with the first attachment point of the manifold, the first end of the flow tube is engaged with the second end of the valve stem, and the first end of the nozzle is engaged with the second end of the flow tube and the manifold second attachment point.

11. The remotely controlled material delivery system of claim 8, wherein the nozzle is attached to the manifold by a “quick-connect” fitting.

12. The remotely controlled material delivery system of claim 8, wherein:
the valve actuator is a substantially flat insert;
the valve actuator at least partially extends from the first end of the valve stem; and
the valve actuator is in contact with the sealable port of the at least one canister.

13. The remotely controlled material delivery system of claim 8, further comprising:
a fluid flow assembly including:
the nozzle;
the valve mechanism;
the flow tube;
a check valve;
a one-way stop abutting the valve plate;
wherein the valve plate is oil-filled bronze;
a servo cover plate, which at least partially covers the actuator system and fluid flow assembly;
a printed circuit board (PCB) disposed within the manifold;
wherein the printed circuit board (PCB) is electrically connected to the power source and the signal receiver; and
wherein the signal receiver is an antenna.

14. The remotely controlled material delivery system of claim 8, wherein the remote controller further comprises:
a controller housing having an upper case and a lower case;
an input mechanism;
a light pipe;
a printed circuit board (PCB);
wherein the input mechanism, light pipe, and printed circuit board are disposed within the controller housing; and
wherein the input mechanism and light pipe extend at least partially outside the controller housing.

15. A remotely controlled material delivery system comprising:
a material hose configured to deliver a material to be dispensed;
a nozzle, separate from the at least one canister, having a first end and a second end;
a manifold, separate from the at least one canister and having a first attachment point and a second attachment point, to direct movement of the material from the material hose to the nozzle;
a valve mechanism, affixed to the manifold, and having:
a valve base;
a valve stem, having a first end and a second end;
a valve actuator disposed at the first end of the valve stem;
a valve plate, disposed at the second end of the valve stem;
wherein the valve base is sealably engaged with the material hose;
wherein the valve stem is slidably engaged with the valve base;
an actuator system having:
a servo motor;
at least one actuator cam rotatably connected to the servo motor;
a flow tube having a first end and a second end;
a signal receiver, incorporated into the manifold, for receiving a signal that causes the actuator system to activate;
a power source, incorporated into the manifold, for providing electric power to energize the actuator system to activate upon receiving the signal;
a remote controller operable to generate the signal wherein the signal is transmitted from the remote controller to the signal receiver through a transmitter circuit, wherein the receiver can activate the actuator system in response to the remotely generated signal;
wherein the servo motor is configured to rotate the at least one actuator cam when the actuator system activates; and
wherein the at least one actuator cam is engaged with the valve plate, and configured such that when the at least one actuator cam rotates, the valve stem will slide vertically, relative to the valve base.

16. The remotely controlled material delivery system of claim 15, further comprising a mounting adapter, incorporated into the manifold, and attached to an adapter at a working end of a hot stick extension that provides access to locations out of physical reach.

17. The remotely controlled material delivery system of claim 15, wherein the material hose is engaged with the first attachment point of the manifold, the first end of the flow tube is engaged with the second end of the valve stem, and the first end of the nozzle is engaged with the second end of the flow tube and the manifold second attachment point.

18. The remotely controlled material delivery system of claim 15, wherein:
the valve actuator is a substantially flat insert;
the valve actuator at least partially extends from the first end of the valve stem; and
the valve actuator is in contact with the sealable port of the at least one canister.

19. The remotely controlled material delivery system of claim 15, further comprising:
a fluid flow assembly including:
the nozzle;
the valve mechanism;
the flow tube;
a check valve;
a one-way stop abutting the valve plate;
wherein the valve plate is oil-filled bronze;
a servo cover plate, which at least partially covers the actuator system and fluid flow assembly;
a printed circuit board (PCB) disposed within the manifold;
wherein the printed circuit board (PCB) is electrically connected to the power source and the signal receiver; and
wherein the signal receiver is an antenna.

20. The remotely controlled material delivery system of claim 15, wherein the remote controller further comprises:
a controller housing having an upper case and a lower case;
an input mechanism;
a light pipe;
a printed circuit board (PCB);
wherein the input mechanism, light pipe, and printed circuit board are disposed within the controller housing; and
wherein the input mechanism and light pipe extend at least partially outside the controller housing.
